(19) United States
(12) Patent Application Publication
(10) Pub. No.: US 2003/0008539 A1
(43) Pub. Date: Jan. 9, 2003

(54) Electrical connector ejector and method of use

(76) Inventor: Patrick Bertke, Columbus, OH (US)

Correspondence Address: JAMES R. ELEY ESQ., THOMPSON HINE LLP, 10 W. BROAD STREET, SUITE 700, COLUMBUS, OH, 43215-3435, US

(21) Appl. No.: 09/901,248

(22) Filed: Jul. 9, 2001

(51) Int. Cl. H01R 13/62

(52) U.S. Cl. 439/160

(57) ABSTRACT

The present invention provides a device and method for separating electrical connector assemblies. Electrical connector assemblies typically comprise a male connector, commonly called a plug, and a female connector, commonly called a receptacle. The separation of an electrical connector assembly is accomplished by at least one lever disposed in the body of at least one of the connectors. The lever is attached to the body of the connector such that when the lever is “up” the lower portion of the lever is flush with the mating surface so as not to not interfere with the coupling of the connector. Actuation of the lever, i.e., moving the lever to its down position, causes a displacement of at least one the connectors comprising the electrical connector assembly. The present invention may be adapted to a wide range of electrical connectors including, but not limited to: standard household plug and sockets, parallel connectors, serial connectors, and inline connectors.

### TECHNICAL FIELD OF INVENTION

The present invention is in the field of electrical connectors. Specifically, the present invention is related to assisted-release electrical connectors.

### BACKGROUND AND SUMMARY OF THE INVENTION

Many electrical devices rely upon power cords to connect the device to a power source, such as an electrical outlet on a wall. In addition, extension cords are often required to extend the range of the electrical device from an outlet due to poor outlet availability or because the power cord of the electrical device is too short to reach an available outlet.

A power cord typically comprises a length of wire wrapped in insulation. Typically, one end of the power cord terminates in a male connector, while the opposite end terminates in a female connector. Connectors are manufactured products designed to terminate conductors and cables between electronic circuits within a system, between systems, and between systems and external power sources and signal lines.

A male connector is commonly referred to as a plug. Examples of plugs include, but are not limited to: a flat blade attachment plug as shown in FIG. 1 (along with an electrical outlet); a flat blade attachment plug with a round grounding pin as shown in FIG. 2; a round pin attachment plug as shown in FIG. 3 (along with an electrical socket); a round pin attachment plug with ground as shown in FIG. 4 (along with an electrical socket); a round pin plug as shown in FIG. 5 (along with a receptacle with a male grounding pin); a “Schuko” plug as shown in FIG. 6 (along with a receptacle with side grounding contacts); a rectangular blade plug as shown in FIG. 7; an oblique flat blade plug with ground as shown in FIG. 8; an oblique flat blade plug (inverted V-shape) with ground as shown in FIG. 9 (along with a socket); a round pin plug with offset ground as shown in FIG. 10 (along with a socket); a round pin plug with spade ground as shown in FIG. 11 (along with a socket); and a round pin plug with in-line ground as shown in FIG. 12 (along with a socket). A male connector, i.e., plug, typically mates with a female connector of the same size and number of conductors. Female connectors are also commonly called recepticals, sockets, jacks, or outlets.

As shown in FIG. 13, a male connector 13a may comprise a body 13c made from an insulating material. The body 13c has a mating surface 13e from which conductive projections 13d extend. The mating surface 13e can be pressed substantially against a mating surface of a female connector (shown in FIG. 14) so as to place the two connectors in electrical communication. The body 13c of the male connector typically houses the connection (not shown) of the wire 13b with the conductive projections 13d.

As shown in FIG. 14, a female connector 14a may comprise a body 14c made from an insulating material. The body 14c has a mating surface 14e in which cavities 14d are formed. The cavities 14d contain conductive receivers 14f adapted to accept the insertion of conductive projections (shown in FIG. 13). The body 14c of the female connector 14a encapsulates the connection (not shown) of the wire 14b with the conductive receivers 14f.

Typically, a plug is held in a receptical after insertion due to an interference fit between the conductive projections of the male connector and the conductive receivers of the female connector. This is sometimes referred to as a force fit because an insertion force may be required to overcome the interaction of the conductive projections of the male connector with the conductive receivers of the female connector when coupling the connectors in the formation of a circuit. A male connector coupled with a female connector is referred to as a connector assembly. A connector assembly can typically be uncoupled by applying sufficient force to pull the the male and female connectors apart. However, the amount of force required to uncouple the connectors can often be excessive for people with low hand strength. Such people may have difficulty seperating the connectors. A partially seperated connector assembly may be a hazard as it exposes the conductive projections of the male connector such that another conductive material may contact the projections and short the circuit.

Accordingly, a need exists to provide an electrical connector that is easily seperable by persons having low hand strength such as the elderly, the physically challenged, or normally heathly persons too weak to seperate a connector assembly. Another need exists to provide a method for seperating electrical connectors.

Preferred embodiments of the present invention satisfy some or all of these needs. In addition, it will be appreciated that similar advantages may be obtained in other applications of the present invention. Such advantages may become apparent from the present disclosure or through practice of the present invention.

The present invention provides an electrical connector as well as a method for separating connectors of electrical connector assemblies. The electrical connector may be a male connector, a female connector, or any other similar, suitable, or conventional type of connector. An example of a male connector is a plug, and examples of female connectors include jacks, sockets, receptacles, and wall outlets. The electrical connector includes a lever that is pivotally connected to the body. Force may be applied to one end of the lever, thereby causing the opposing end of the lever to move outwardly from the mating surface of the connector. The lever may be pivotally attached to the body of the connector in such a way as to not interfere with the connection between the connectors during engagement. The connector may be a part of an electrical connector assembly. Electrical connector assemblies may comprise a male connector, e.g., a plug, that is engaged with a female connector, e.g., a receptacle such as a wall outlet. In the present invention, the separation of an electrical connector assembly is accomplished by at least one lever that is pivotally connected to the body of at least one of the connectors.

The present invention is not limited to any specific type or use of electrical connector. One preferred embodiment of the present invention is particularly useful with two-conductor or three-conductor, male or female power connectors, e.g., with power cords, extension cords, or other similar, suitable, or conventional power cables. Nevertheless, the present invention may be implemented with any of the connectors described above in the background as well as other similar, suitable, or conventional connectors that are now known or may be later developed. Examples of other connectors to which the present invention may be applied include, but should not be limited to, other serial connectors, parallel connectors, and in-line connectors. The connectors may be used for any suitable purpose such as for power distribution (e.g., with power strips, wall outlets, power cords, extension cords, and other similar, suitable, or conventional power distribution systems), data transmission, control signal transmission, response signal transmission, timing signal transmission, and other similar, suitable, or conventional uses that are now known or may be later developed. In addition, it should be recognized that the present invention may be used to separate connector/wall outlet assemblies as well as any other similar, suitable, or conventional type of electrical connector assembly.

In addition to the novel features and advantages mentioned above, other objects and advantages of the present invention will be readily apparent from the following descriptions of the drawings and exemplary embodiments.

### BRIEF DESCRIPTION OF THE DRAWINGS

FIG. 1 is a perspective view of a flat blade attachment plug and receptacle of the prior art;

FIG. 2 is a perspective view of a flat blade plug with round grounding pin of the prior art;

FIG. 3 is a side elevation view of a round pin attachment plug and a receptacle of the prior art;

FIG. 4 is a perspective view of a round pin plug with ground and a receptacle of the prior art;

FIG. 5 is a perspective view of a round pin plug and a receptacle with male grounding pin of the prior art;

FIG. 6 is a perspective view of a “Schuko” plug and a receptacle with side grounding contacts of the prior art;

FIG. 7 is a perspective view of a rectangular blade plug of the prior art;

FIG. 8 is a side elevation view of an oblique flat blade plug (V-shaped) with ground of the prior art;

FIG. 9 is a side elevation view of an oblique flat blade plug (inverted V) with ground and a receptacle of the prior art;

FIG. 10 is a side elevation view of a round pin plug with round offset grounding pin and a receptacle of the prior art;

FIG. 11 is a side elevation view of a round pin plug with spade grounding pin and a receptacle of the prior art;

FIG. 12 is a side elevation view of a round pin plug with in-line round grounding pin and a receptacle of the prior art;

FIG. 13 is a side elevation view of a male connector of the prior art;

FIG. 14 is a side elevation view of a female connector of the prior art;

FIG. 15 is a side elevation view of a male connector ejector in accordance with one embodiment of the present invention;

FIG. 16 is a side elevation view of a female connector ejector in accordance with one embodiment of the present invention;

FIG. 17 is a side elevation view of the mating surface of a male connector ejector body in accordance with one embodiment of the present invention;

FIG. 18 is a side elevation view of a male electrical connector ejector with the lever in an up position, in accordance with one embodiment of the present invention;

FIG. 19 is a side elevation view of the male electrical connector ejector of FIG. 18 with the lever mid-way between the up and the down position;

FIG. 20 is a side elevation view of the male electrical connector ejector of FIG. 18 with the lever in a down position;

FIG. 21 is a side elevation view of a male electrical connector ejector fully engaging a female connector;

FIG. 22 is a side elevation view of the male electrical connector ejector partially ejected from the female connector of FIG. 21;

FIG. 23 is a side elevation view of the male electrical connector ejector fully ejected from the female connector of FIG. 21;

FIG. 24 is a side elevation view of the mating surface of a female connector ejector body in accordance with one embodiment of the present invention;

FIG. 25 is a side elevation view of a female electrical connector ejector with the lever in an up position, in accordance with one embodiment of the present invention;

FIG. 26 is a side elevation view of the female electrical connector ejector of FIG. 25 with the lever mid-way between the up and the down position;

FIG. 27 is a side elevation view of the female electrical connector ejector of FIG. 25 with the lever in a down position;

FIG. 28 is a side elevation view of a male connector ejector with the lever in a down position, in accordance with another embodiment of the present invention;

FIG. 29 is a side elevation view of the male connector ejector of FIG. 28 with the lever in an up position;

FIG. 30 is a partial side elevation view of a lever of a connector ejector biased in an up position, in accordance with yet another embodiment of the present invention; and

FIG. 31 is a partial side elevation view of the connector ejector of FIG. 30 with the lever in a down position.

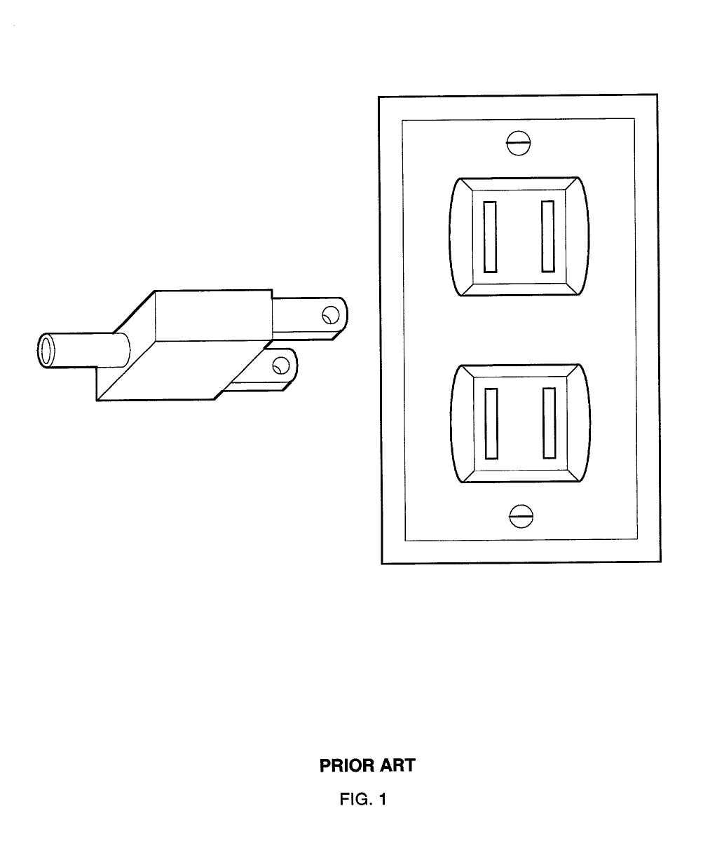

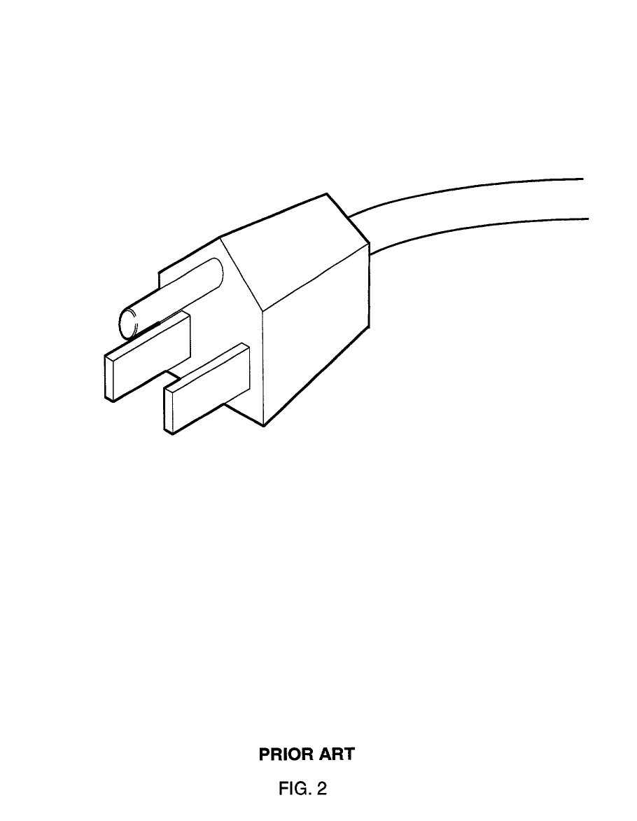

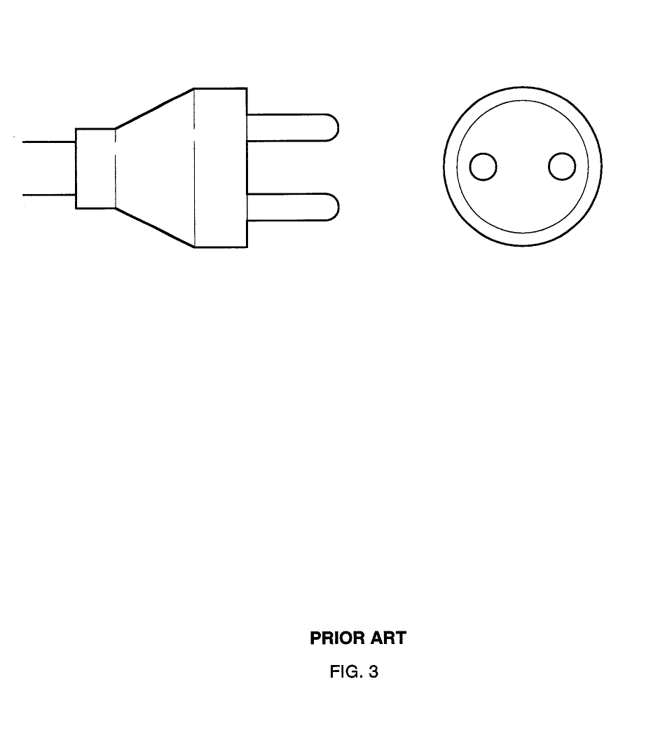

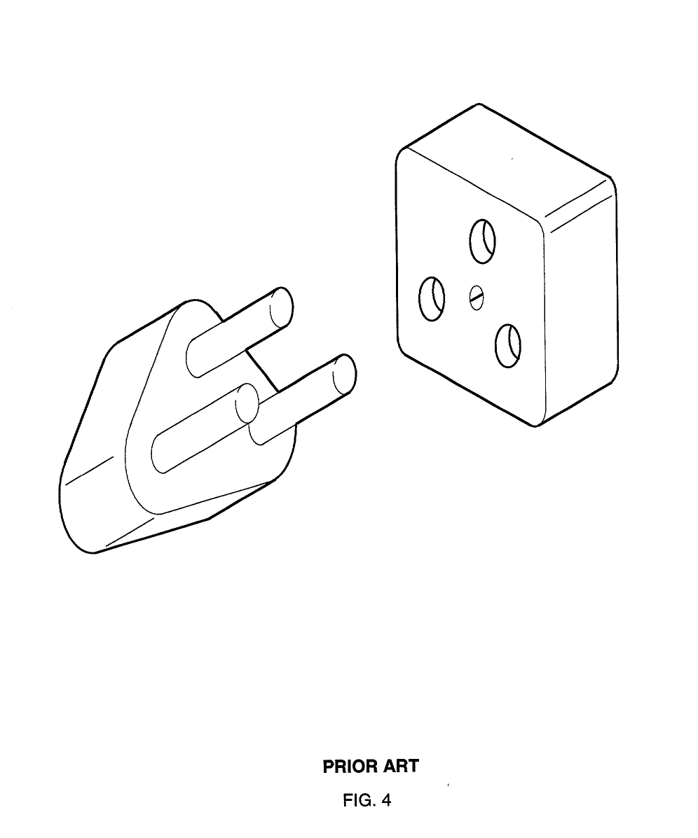

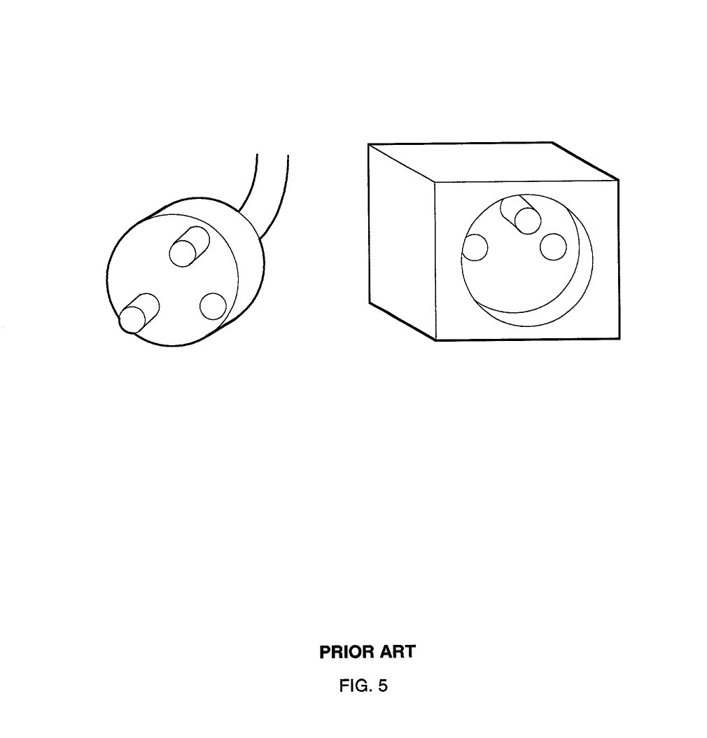

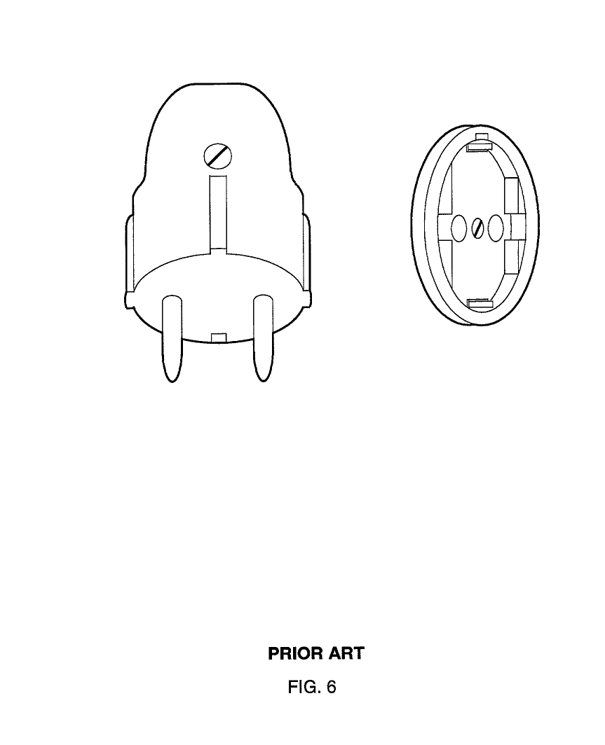

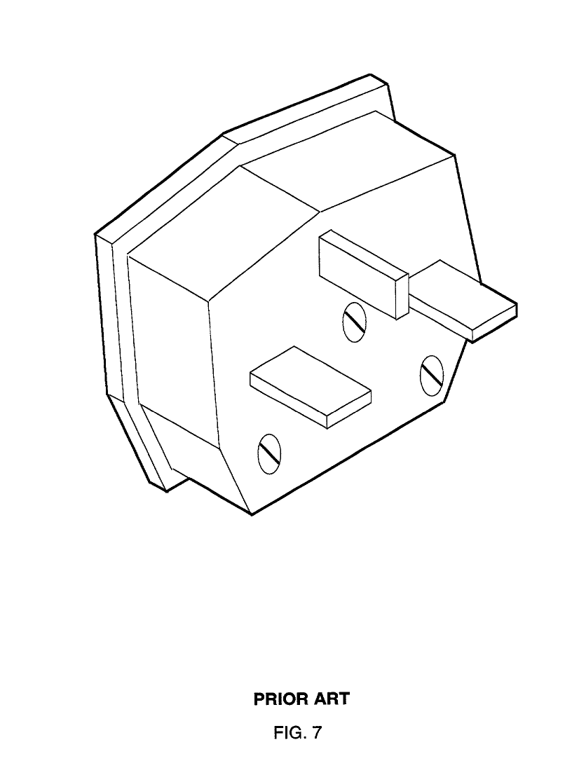

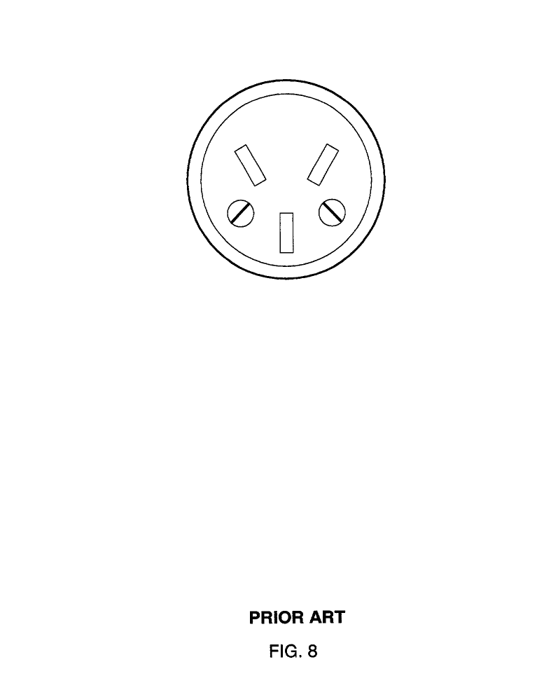

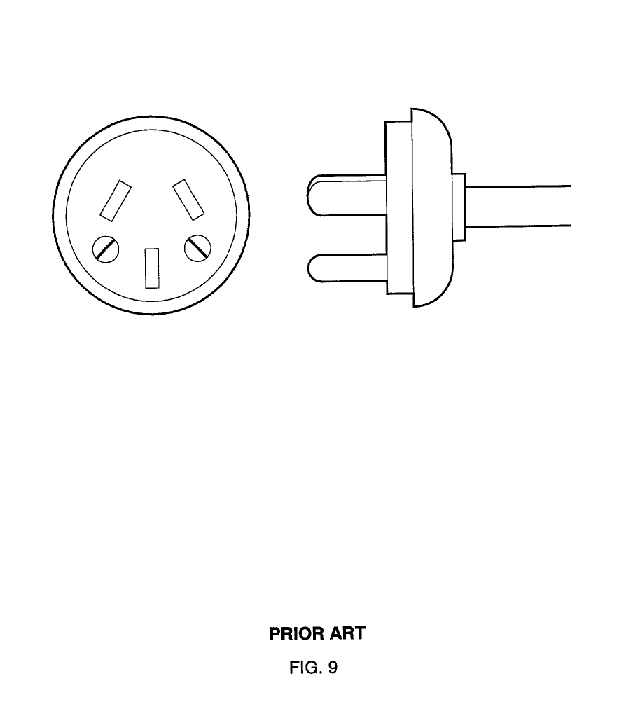

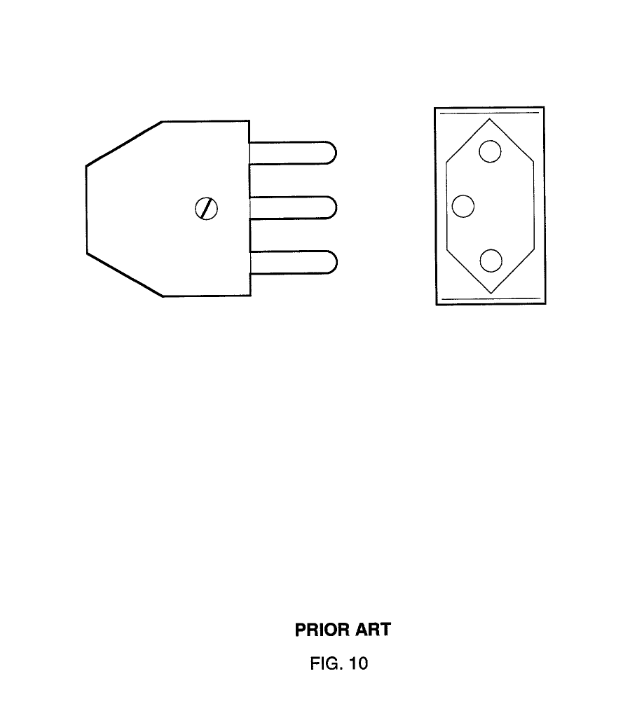

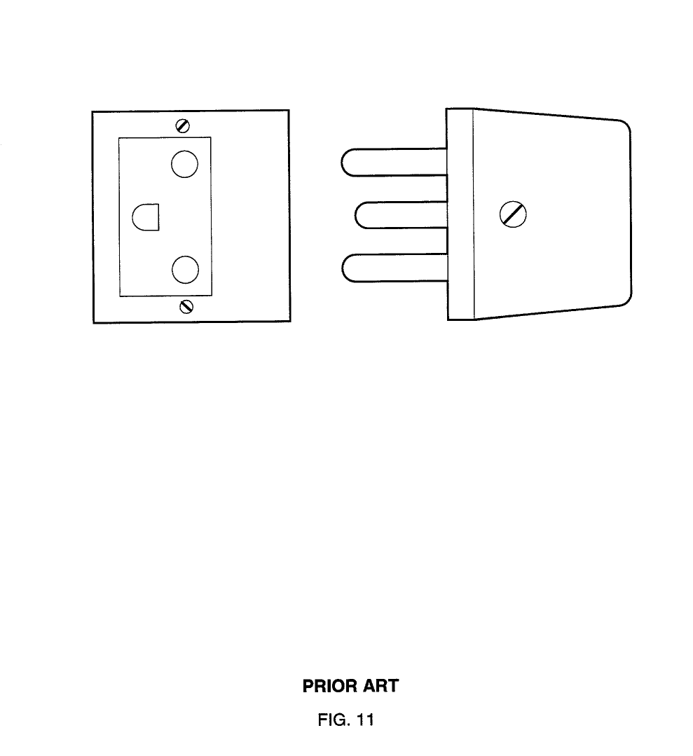

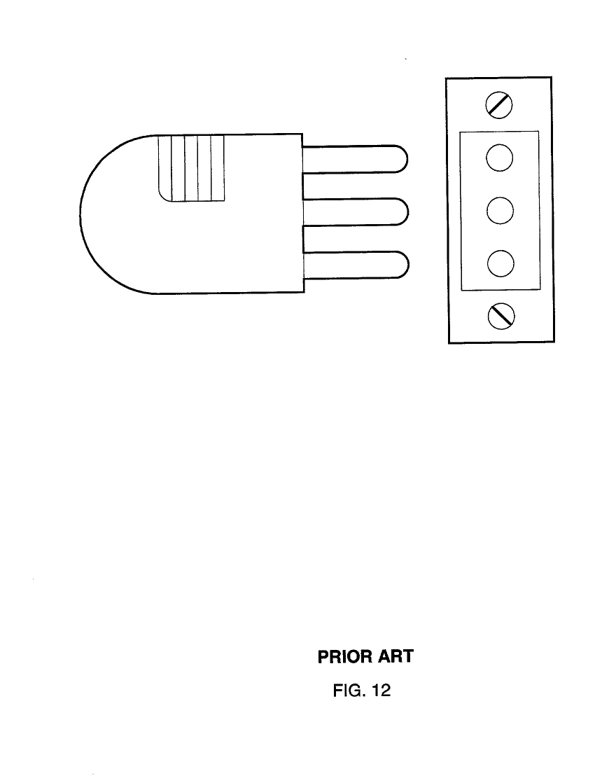

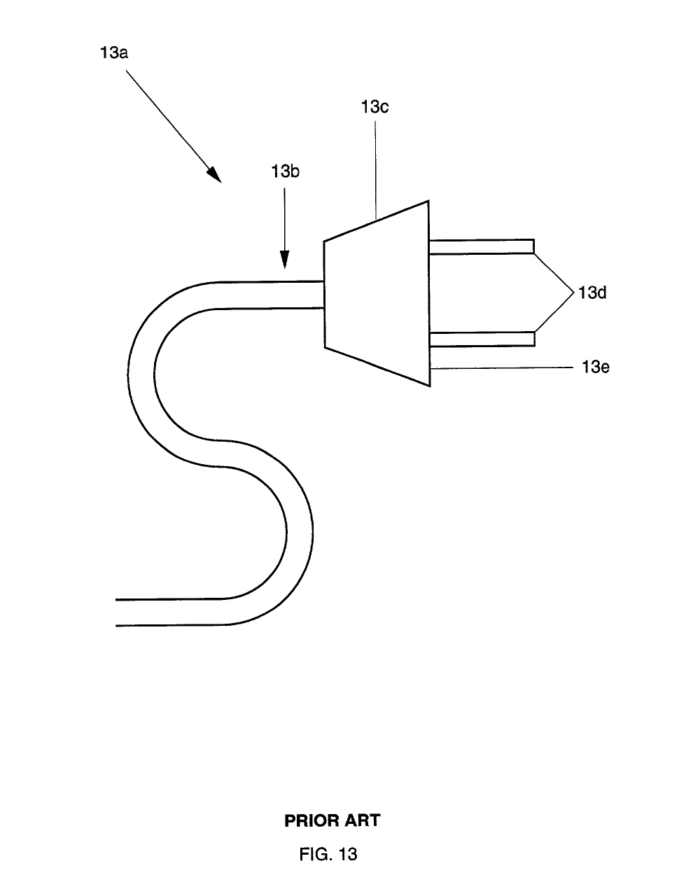

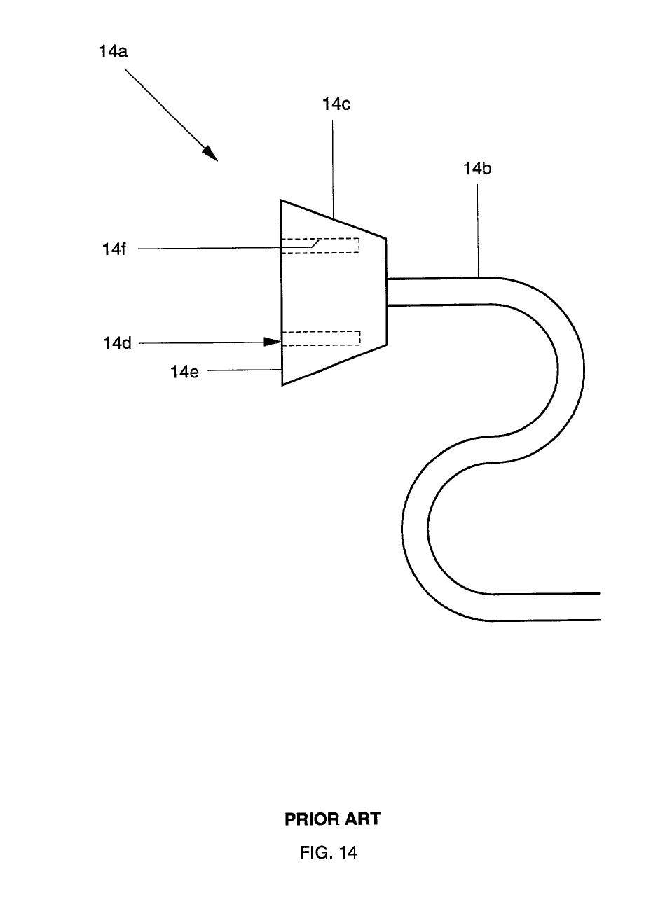

### DETAILED DESCRIPTION OF THE PREFERRED EMBODIMENTS

In accordance with the foregoing summary, the following presents a detailed description of the preferred embodiments of the invention that are currently considered to be the best mode.

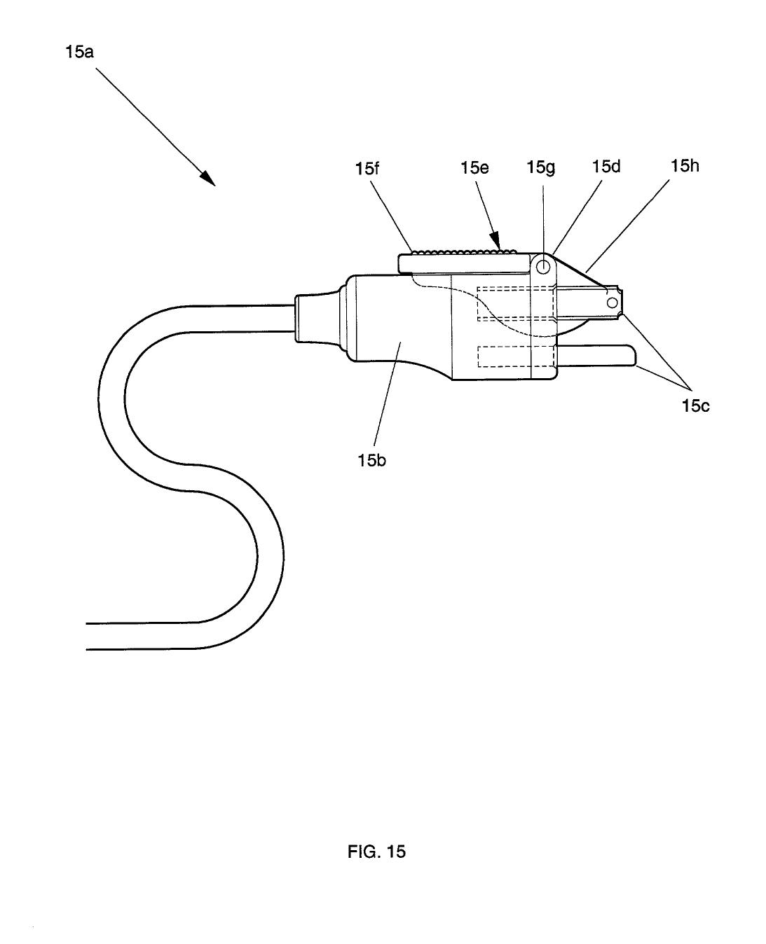

FIG. 15 shows a side view of a male connector ejector 15a of the present invention. This embodiment of the male connector ejector 15a comprises: (1) a body 15b having conductive projections 15c and an attachment means 15d and (2) a lever 15e that is connected to the body 15b. In this example, the lever 15e is mounted at least partially in a channel of the body 15b. However, in other embodiments, the lever 15e may be located along an outside portion of the body 15b. The lever 15e may be comprised of an upper portion 15f, an engagement means 15g, and a lower portion 15h. The lever 15e is pivotally or rotatably connected to the body 15b. Any suitable combination of attachment means 15d and engagement means 15g may be used to pivotally or rotatably connect the lever 15e to the body 15b. Examples of suitable attachment means 15d include, but are not limited to, female connecting portions, male connecting portions, posts, holes, apertures, receptacles, rods, axles, pins, chains, sprockets, belts, pulleys, balls, sockets, hinges, trunnions, and clips. Similarly, examples of suitable engagement means 15g include, but are not limited to, female connecting portions, male connecting portions, posts, holes, apertures, receptacles, rods, axles, pins, chains, sprockets, belts, pulleys, balls, sockets, hinges, trunnions, and clips. In this particular example, posts 15g are adapted to rotate in respective apertures 15d. As a result, the attachment means 15d and engagement means 15g cooperate in order to permit the lever 15e to pivot or rotate in relation to the body 15b.

The upper portion 15f of the lever 15e is where a person may exert a force to separate the connector 15a from another connector of an electrical connector assembly. It is preferred that the upper portion 15f of the lever 15e comprises a finger pad, a portion for the comfortable placement of a human finger to exert a force upon. The finger pad may have a texture and/or contoured surface for ergonomic advantage and/or to ensure good contact between the finger pad and the user's fingers.

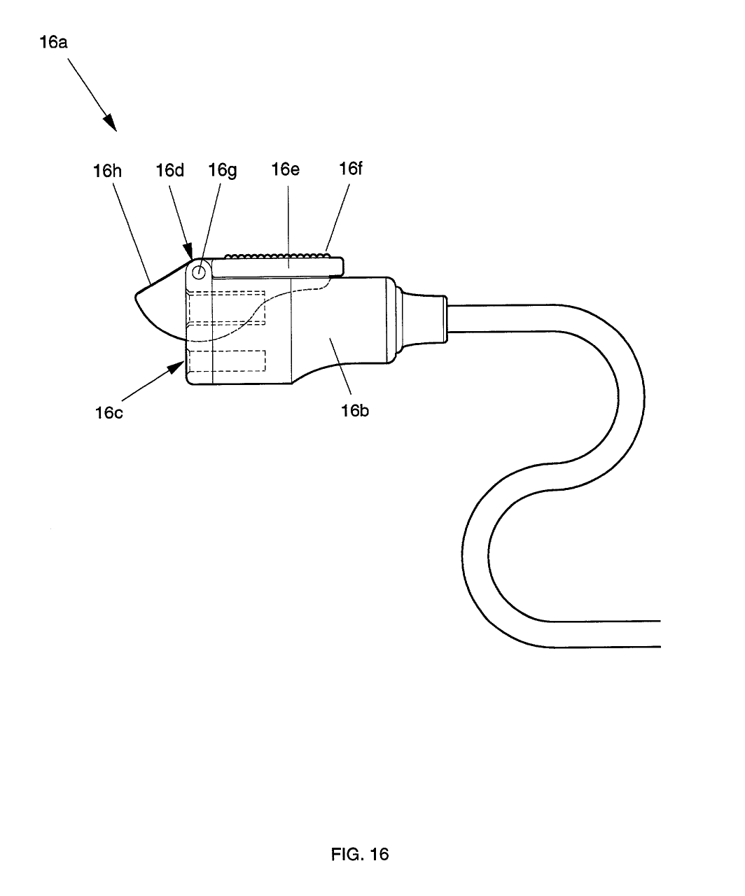

FIG. 16 shows a side view of a female connector ejector 16a of the present invention. The female connector ejector 16a may include any of the optional or preferred features of the male connector ejector 15a. The female connector ejector 16a comprises: (1) a body 16b having conductive receivers 16c and an attachment means 16d and (2) a lever 16e that is connected to the body 16b. The lever 16e may be comprised of an upper portion 16f, an engagement means 16g and a lower portion 16h. In this example, the lever 16e is mounted at least partially in a channel of the body 16b. However, in other embodiments, the lever 16e may be located along an outside portion of the body 16b. The lever 16e is pivotally or rotatably connected to the body 16b. Any suitable combination of attachment means 16d and engagement means 16g may be used to pivotally or rotatably connect the lever 16e to the body 16b. Examples of suitable attachment means 16d include, but are not limited to, female connecting portions, male connecting portions, posts, holes, receptacles, apertures, rods, axles, pins, chains, sprockets, belts, pulleys, balls, sockets, hinges, trunnions, and clips. Similarly, examples of suitable engagement means 16g include, but are not limited to, female connecting portions, male connecting portions, posts, holes, apertures, receptacles, rods, axles, pins, chains, sprockets, belts, pulleys, balls, sockets, hinges, trunnions, and clips. In this particular example, posts 16g are adapted to rotate in respective apertures 16d. As a result, the attachment means 16d and engagement means 16g cooperate in order to permit the lever 16e to pivot or rotate in relation to the body 16b.

A person may exert a force on the upper portion 16f of the lever 16e to separate the connector 16a from another connector of an electrical connector assembly. It is preferred that the upper portion 16f of the lever 16e comprises a finger pad, a portion for the comfortable placement of a human finger to exert a force upon. The finger pad may have a texture and/or uneven surface to ensure good contact between the finger pad and the user's fingers.

The present invention may also be implemented in connectors that have a combination of male and female conductive portions. Additionally, one or each connector of an electrical connector assembly may be an electrical connector ejector of the present invention. The following examples will discuss the present invention in further detail.

### EXAMPLE ONE

### Only Male Connector Having an Ejection Lever

In this embodiment, the disengagement of the male connector ejector from the female connector is accomplished by a lever. FIG. 17 shows the body 17a of a male connector ejector of the present invention which has a channel 17b extending from a side surface 17c to the mating surface 17d. The lever is not shown in order to more clearly show the channel 17b. The channel 17b may have any suitable shape to allow the lever to rotate or pivot from an up or closed position to a down or open position. Any suitable portion of the body 17a may form attachment means 17e. In this example, the attachment means 17e is formed at an edge of the side surface 17c and the mating surface 17d. The attachment means 17e interacts with engagement means on the lever (not shown) to connect the lever to the body 17a of the male connector. As noted above, the attachment means 17e may be a receptacle or any other suitable attachment device adapted to engage the engagement means of the lever to pivotally connect the lever to the body 17a. The attachment means 17e and the engagement means of the lever act together to form the fulcrum point of the lever.

The lever may be a type 1 lever, meaning that the fulcrum is situated between the applied force and the load. However, the lever may be any other suitable type of lever, e.g., a type 2 or 3 lever. The lever may have three main portions: an upper portion, an engagement means, and a lower portion. The upper portion is that portion of the lever upon which a user may apply a force to the lever. The engagement means of the lever interacts with the attachment means of the body to form the fulcrum and pivotally connect the lever to the body of the male connector. The lower portion of the lever may reside at least partially in the channel of the body when the lever is an up or closed position. When the lever is moved to a down or open position, the lower portion of the lever contacts the female connector, preferably the mating surface, to push apart the male and female connectors of the connector assembly.

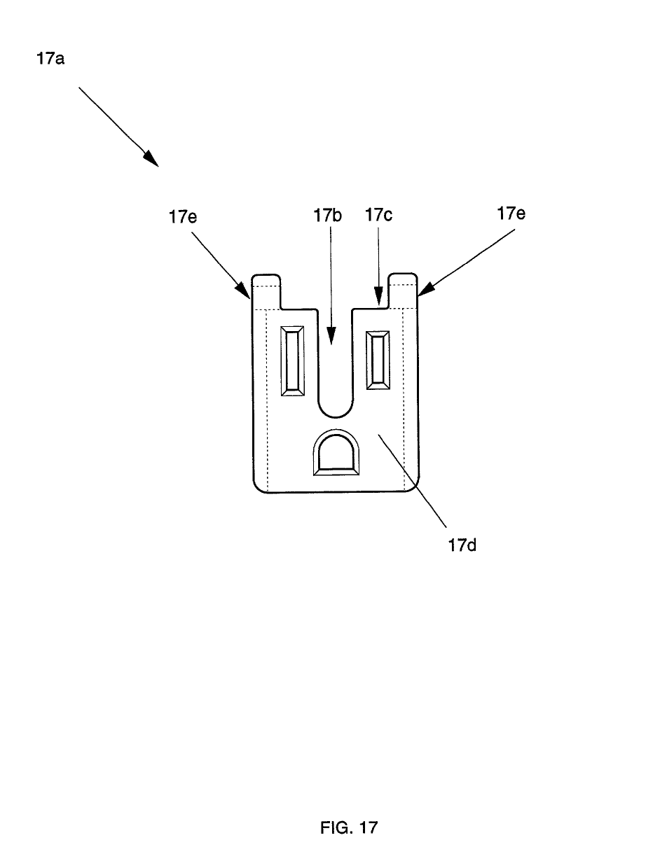

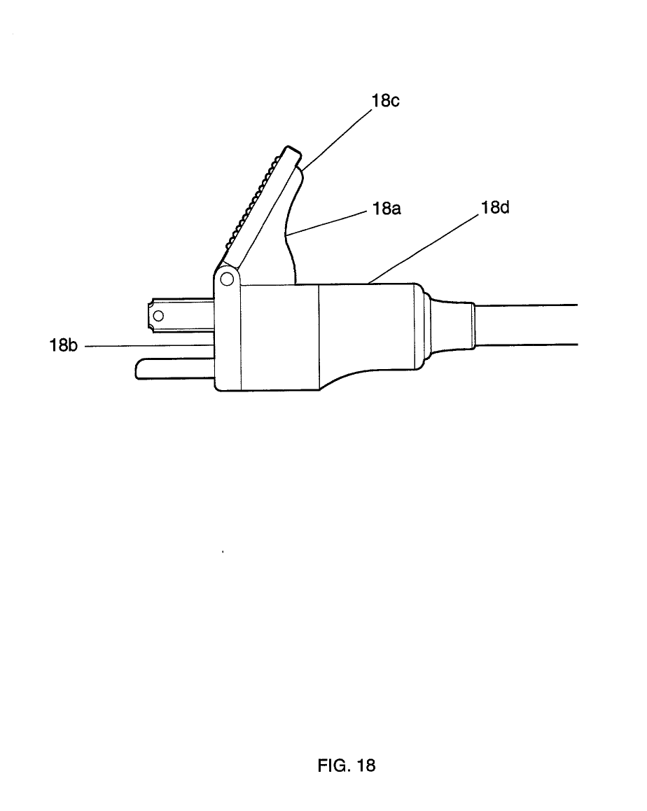

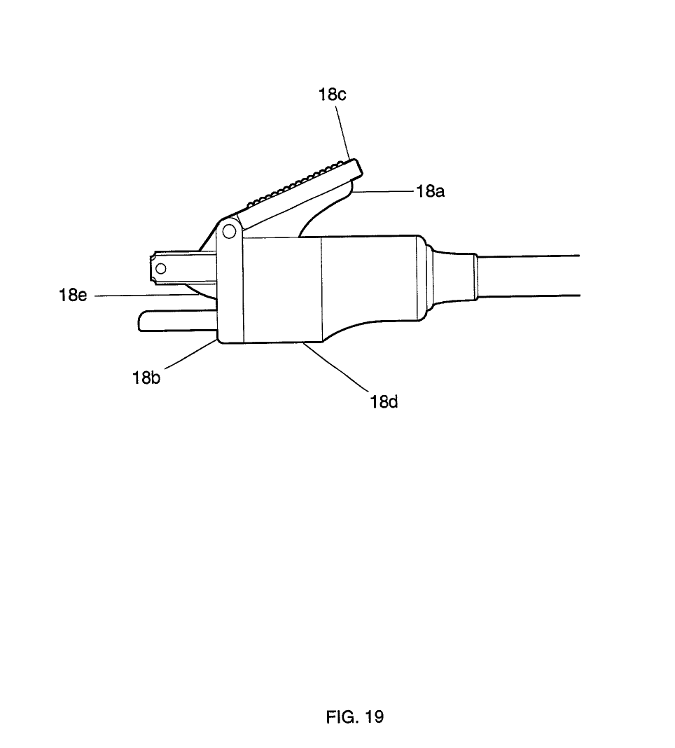

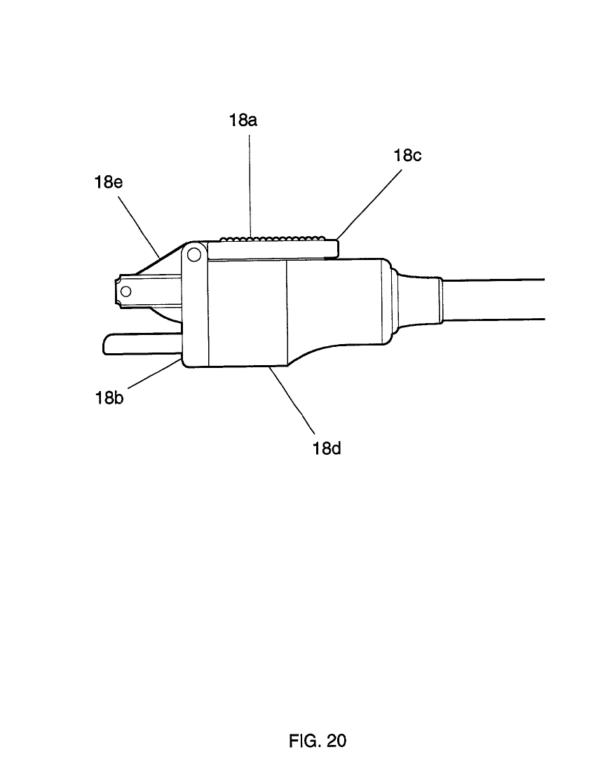

When the lever 18a is in the up position as seen in FIG. 18, the lower portion of the lever 18a may be substantially flush with the mating surface 18b of the connector. However, in alternative embodiments, the lower portion of the lever 18a may protrude from, or be recessed from, the mating surface 18b. As the lever 18a is moved towards its down position, the upper portion 18c of the lever 18a moves towards the body 18d of the connector while the lower portion 18e simultaneously moves outward from the mating face 18b, as in FIG. 19. Upon reaching the down position, the upper portion 18c of the lever 18a rests against the body 18d of the connector and the lower portion 18e of the lever 18a is fully extended as in FIG. 20.

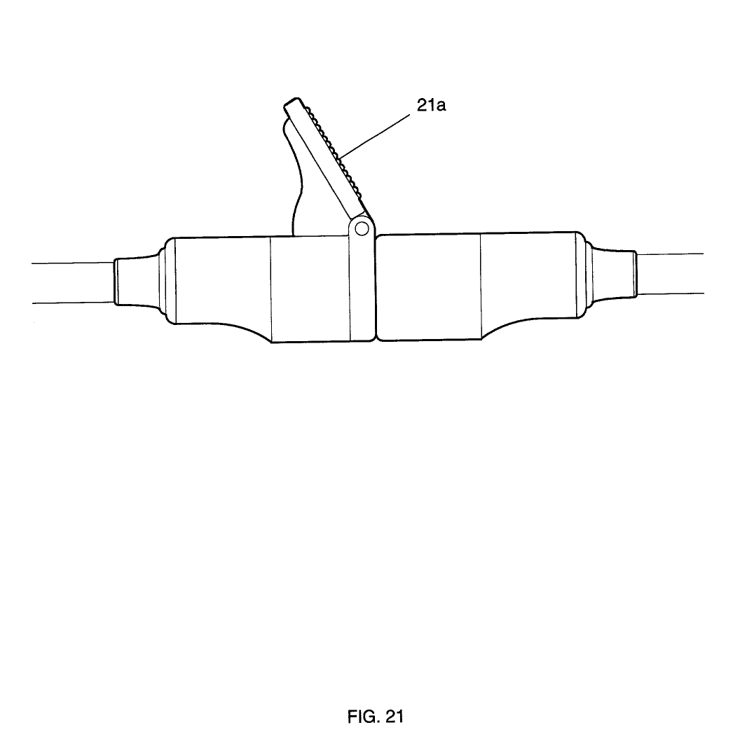

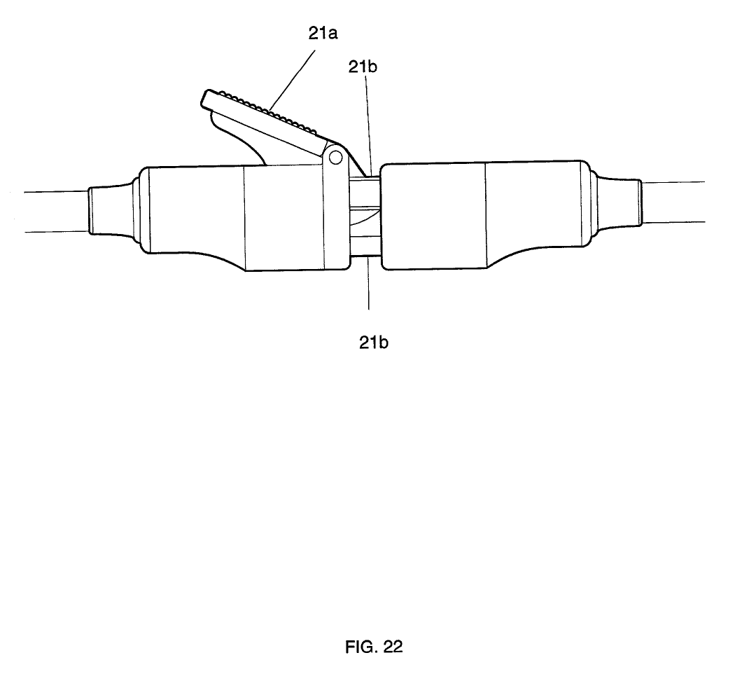

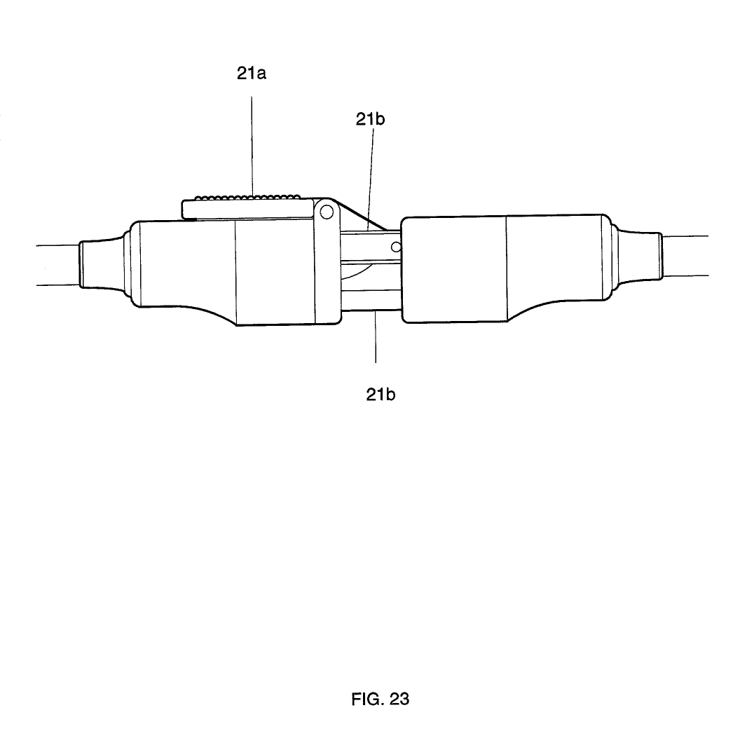

The rotation of the lever 21 a about its fulcrum causes a displacement of a female connector as shown in FIGS. 21-23. As the lever 21a is moved to its down position, the male conductive portions 21b are at least partially or totally disengaged from the female conductive portions. In the example of FIG. 23, the male conductive portions 21b are partially disengaged from the female conductive portions. In this position, the amount of force required to completely seperate the male and the female connectors is preferably much lower than it was before actuating the lever.

### EXAMPLE TWO

### Only Female Connector Having an Lever

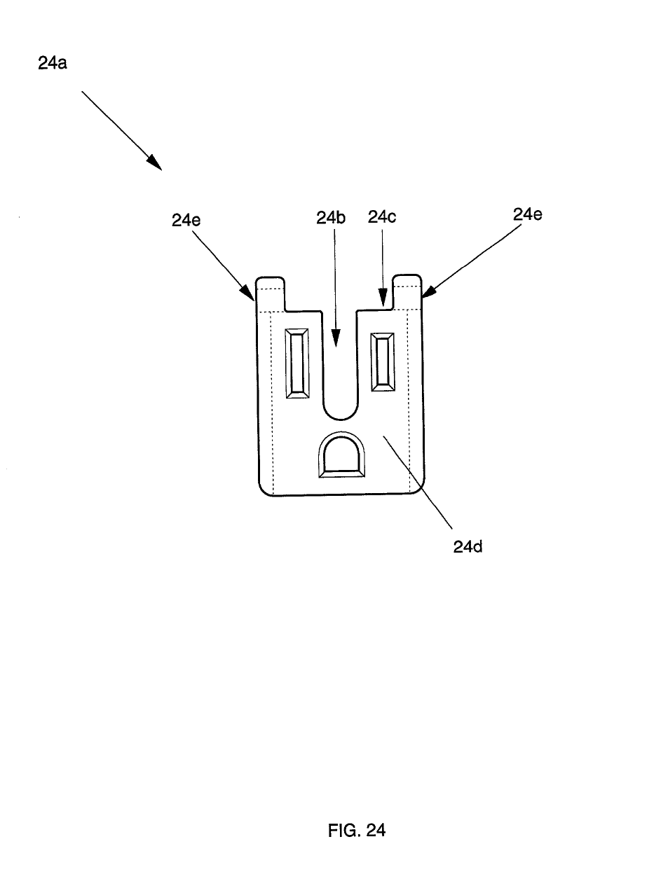

In this embodiment, the disengagement of the female connector ejector from the male connector is accomplished by a lever. This embodiment may include any of the optional or preferred features of the previous embodiments. FIG. 24 shows the body 24a of a female connector ejector of the present invention which has a channel 24b extending from a side surface 24c to the mating surface 24d. The lever is not shown in order to more clearly show the channel 24b. The channel 24b may have any suitable shape to allow the lever to rotate or pivot from an up or closed position to a down or open position. Any suitable portion of the body 24a may form attachment means 24e. In this example, the attachment means 24e is formed at an edge of the side surface 24c and the mating surface 24d. The attachment means 24e interacts with engagement means on the lever (not shown) to connect the lever to the body 24a of the female connector. As noted above, the attachment means 24e may be a receptacle or any other suitable attachment device adapted to engage the engagement means of the lever to pivotally connect the lever to the body 24a. The attachment means 24e and the engagement means of the lever act together to form the fulcrum point of the lever.

The lever may be a type 1 lever, meaning that the fulcrum is situated between the applied force and the load. However, the lever may be any other suitable type of lever, e.g., a type 2 or 3 lever. The lever may have three main portions: an upper portion, an engagement means, and a lower portion. The upper portion is that portion of the lever upon which a user may apply a force to the lever. The engagement means of the lever interacts with the attachment means of the body to form the fulcrum and pivotally connect the lever to the body of the female connector. The lower portion of the lever may reside at least partially in the channel of the body when the lever is an up or closed position. When the lever is moved to a down or open position, the lower portion of the lever contacts the male connector, preferably the mating surface, to push apart the male and female connectors of the connector assembly.

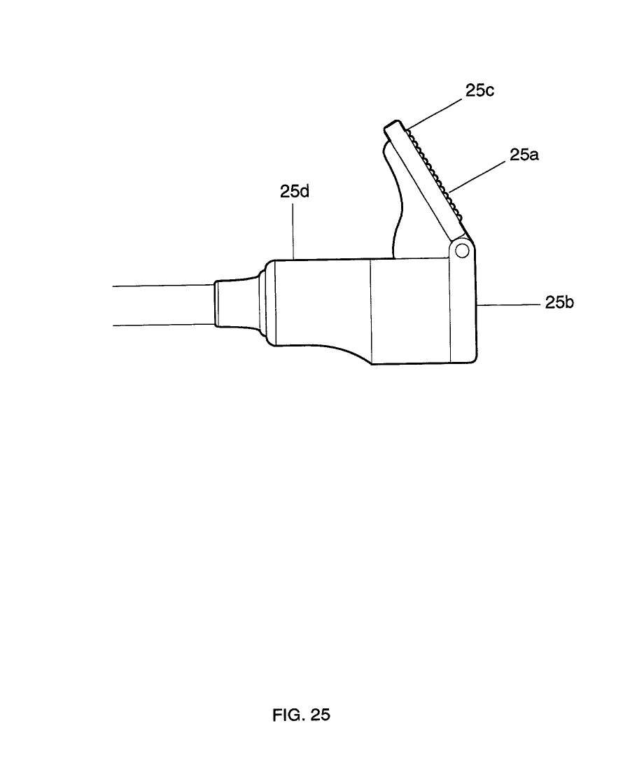

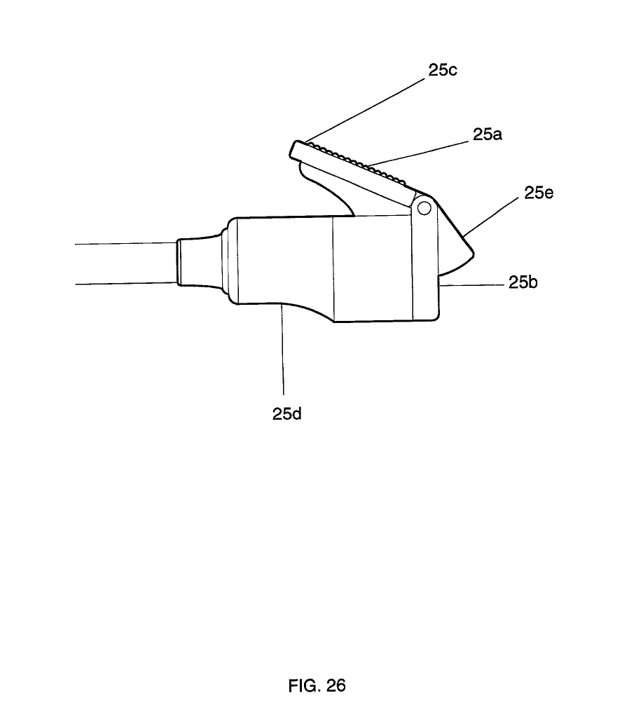

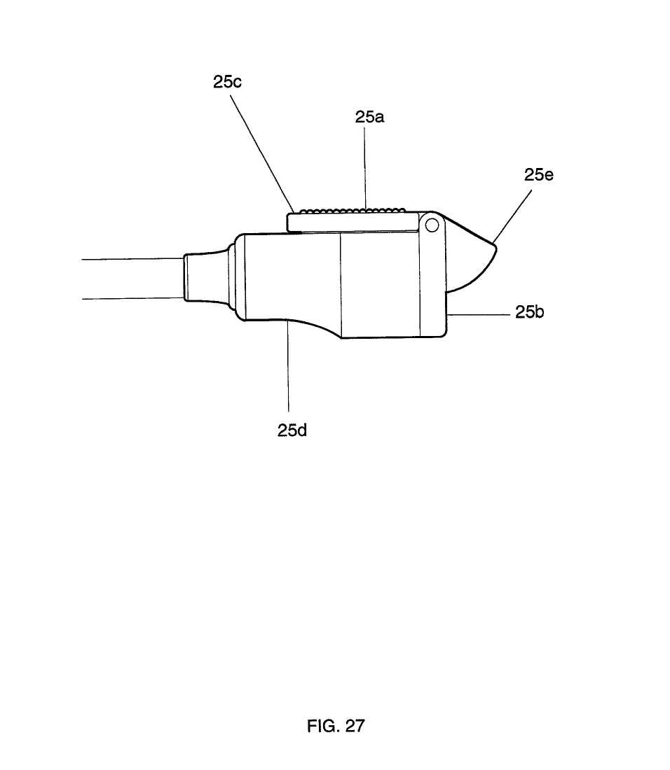

When the lever 25a is in the up position as seen in FIG. 25, the lower portion of the lever 25a may be substantially flush with the mating surface 25b of the connector. However, in alternative embodiments, the lower portion of the lever 25a may protrude from, or be recessed from, the mating surface 25b. As the lever 25a is moved towards its down position, the upper portion 25c of the lever 25a moves towards the body 25d of the connector while the lower portion 25e simultaneously moves outward from the mating face 25b, as in FIG. 26. Upon reaching the down position, the upper portion 25c of the lever 25a rests against the body 25d of the connector and the lower portion 25e of the lever 25a is fully extended as in FIG. 27.

As with the male connector ejector described above, the rotation of the lever of a female connector ejector about its fulcrum initiates the separation of engaged connectors. As the lever is moved to its down position, the male conductive portions are at least partially or totally disengaged from the female conductive portions. In the partially disengaged position, the amount of force required to completely seperate the male and the female connectors is preferably much lower than it was before actuating the lever.

### EXAMPLE THREE

### Both Male and Female Connectors Having Levers

In this embodiment, the disengagement of a male connector from a female connector is accomplished by levers disposed in each connector. The male connector ejector and the female connector ejector may include any of the optional or preferred features of the above described embodiments. In order to separate the connectors, the lever of each connector may be actuated. The levers may be offset or aligned. Consequently, when the levers are moved to their down positions, the lower portions of the levers may abut each other or the opposing mating surface to push apart the connectors.

### EXAMPLE 4

### Connector Having a Cable Disposed at an Angle Relative to the Male or Female Conductive Portions

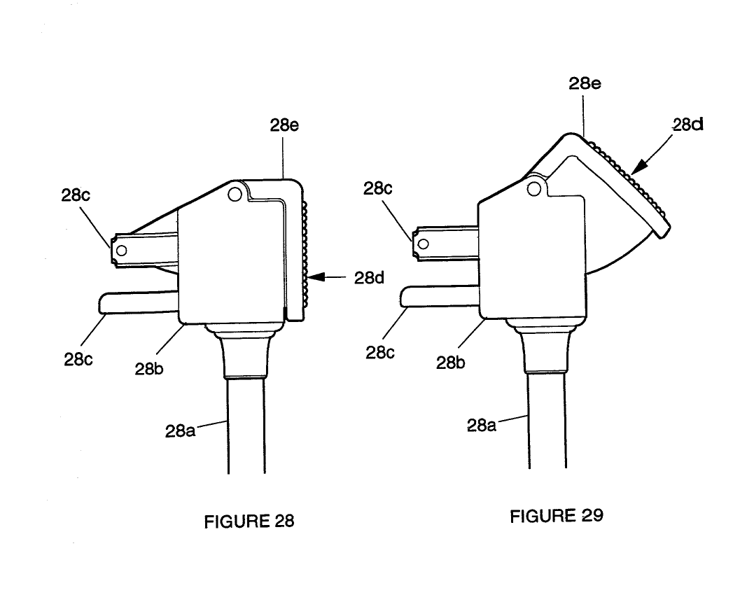

The lever of the present invention may have any shape which is suitable for the particular application. FIGS. 28 and 29 show one example of an alternative shape of a lever of the present invention. In this example, a cable 28a terminates in a connector body 28b. Male conductive portions 28c extend from the connector body 28b at an angle relative to the cable 28a. In this particular example, the angle is about 90 degrees. Nevertheless, it should be recognized that the relationship between the cable 28a and the conductive portions 28c may be any angle greater or less than 90 degrees. A lever 28d is pivotally mounted to the connector body 28b. The lever 28d may include any of the optional or preferred features of the levers described above. The lever 28d of this example has a curved or contoured upper portion 28e. The degree of curvature of the upper portion 28e may be any amount. In this example, the upper portion 28e has about a 90 degree curve such that the upper portion 28e substantially rests against the connector body 28b when the lever 28d is in a down position. Such an embodiment may be useful to limit the amount of space used by the present invention. This embodiment of the present invention may also be implemented in connectors having female conductive portions.

### EXAMPLE 5

### Lever Biased in an Up Position

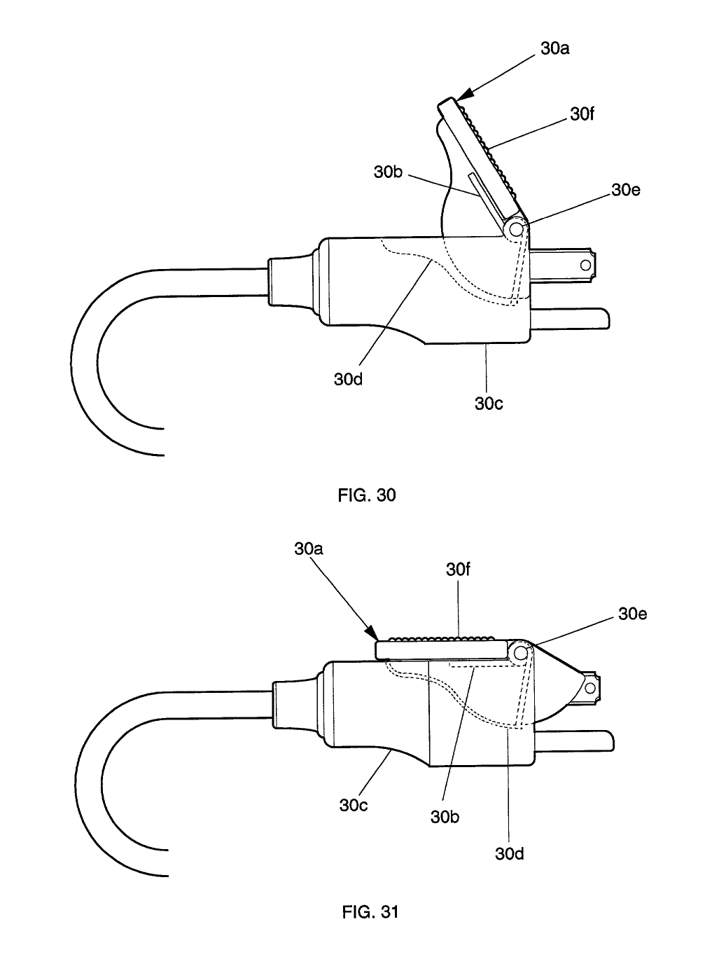

The lever of the present invention may be biased in an up or a down position. In the example shown in FIG. 30, the lever 30a is biased in an up position by a spring 30b or any other similar, suitable, or conventional device that may be biased in a certain direction or position. An example of a spring 30b includes, but is not limited to, a torsion spring or any other similar, suitable, or conventional type of spring. This embodiment of the present invention may include any of the optional or preferred features of the earlier described embodiments of the present invention. Although the figures show a connector having male conductive portions, it should be recognized that this embodiment of the present invention may also be implemented in a connector having female conductive portions.

The spring 30b may be connected to the connector body 30c in any suitable manner. In this example, the spring 30b is located in the channel 30d of the body 30c and connected to the engagement means 30e of the lever 30a. In other embodiments, the spring 30b may be connected to the attachment means of the body 30c. In addition, it should be recognized that the spring 30b may be located outside of the channel 30d in alternative embodiments.

The spring 30b may be connected to any portion of the lever 30a in order to bias the lever 30a in the desired direction. As shown in the example of FIG. 30, the spring 30b may rest against an upper portion 30f of the lever 30a. Biasing the lever 30a in an up position may be useful to keep the lever 30a out of the way when engaging two connectors together. The spring 30b may have any tension which is suitable for the intended purpose. In order to disconnect two connectors, the lever 30a may be moved to a down position as shown in FIG. 31.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. An electrical connector ejector assembly, said electrical connector ejector assembly comprising:
(a) a male connector ejector comprising:
(1) a body, said body comprising a side surface and a mating surface, said mating surface having at least one conductive projection extending therefrom, said body further comprising a channel extending from said side surface to said mating surface, said side surface having an attachment means defining a fulcrum about which a lever can pivot;
(2) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a female electrical connector coupled to said male electrical connector as said lever is pivoted from said up position to said down position;
(b) a female connector ejector comprising:
(1) a body; said body comprising a side surface and a mating surface, said mating surface having at least one conductive receiver adapted to receive a conductive projection, said body further comprising a channel extending from said side surface to said mating surface, said side surface having an attachment means defining a fulcrum about which a lever can pivot;
(2) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a male electrical connector coupled to said male electrical connector as said lever is pivoted from said up position to said down position;
wherein said male connector ejector is disengaged from said female connector ejector by simultaneously pivoting each said lever from its respective open position to its respective closed position such that said lever of said male connector ejector exerts a force upon said mating surface of said female connector ejector as said lever of said female connector ejector exerts a force upon said mating surface of said male connector ejector, said forces being sufficient to cause said male connector ejector and said female connector ejector to seperate.

2. An electrical connector assembly as in claim 1, wherein said upper portion of said lever further comprises a finger pad.

3. An electrical connector assembly as in claim 2, wherein said finger pad is textured or contoured.

4. A male electrical connector ejector, capable of engagement with a female connector, comprising:
(a) a body, said body comprising a side surface and a mating surface, said mating surface having at least one conductive projection extending therefrom, said body further comprising a channel extending from said side surface to said mating surface, said side surface having an attachment means defining a fulcrum about which a lever can pivot; and
(b) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a female electrical connector coupled to said male electrical connector as said lever is pivoted from said up position to said down position.

5. A male electrical connector ejector as in claim 4, wherein said upper portion of said lever further comprises a finger pad.

6. A male electrical connector ejector as in claim 5, wherein said finger pad is textured or contoured.

7. A male electrical connector ejector as in claim 4, further comprising a spring connected to said lever such that said lever is biased in a predetermined position.

8. A female electrical connector ejector, capable of engagement with a male connector, comprising:
(a) a body; said body comprising a side surface and a mating surface, said mating surface having at least one conductive receiver adapted to receive a conductive projection, said body further comprising a channel extending from said side surface to said mating surface, said side surface having an attachment means defining a fulcrum about which a lever can pivot; and
(b) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a male electrical connector coupled to said male electrical connector as said lever is pivoted from said up position to said down position.

9. A female connector ejector as in claim 8, wherein said upper portion of said lever comprises a finger pad.

10. A female connector ejector as in claim 9, wherein said finger pad is textured or contoured.

11. A female connector ejector as in claim 8, further comprising a spring connected to said lever such that said lever is biased in a predetermined position.

12. An extension cord having at least one connector ejector, comprising:
(a) a wire, said wire having a first end and a second end;
(b) a male connector conductively attached to said first end of said wire;
(c) a female connector ejector conductively attached to said second end of said wire, said female connector ejector comprising:
(1) a body; said body comprising a side surface and a mating surface, said mating surface having at least one conductive receiver adapted to receive a conductive projection, said body further comprising a channel extending from said side surface to said mating surface, said side surface having an attachment means defining a fulcrum about which a lever can pivot;
(2) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a male electrical connector coupled to said female connector ejector as said lever is pivoted from said up position to said down position.

13. An extension cord of claim 12, wherein said upper portion of said lever comprises a finger pad.

14. An extension cord of claim 13, wherein said finger pad is textured or contoured.

15. An extension cord having at least one connector ejector, comprising:
(a) a wire, said wire having a first end and a second end;
(b) a female connector conductively attached to said first end of said wire;
(c) a male connector ejector conductively attached to said second end of said wire;
(1) a body, said body comprising a side surface and a mating surface, said mating surface having at least one conductive projection extending therefrom, said body further comprising a channel extending from said side surface to said mating surface, said side surface having an attachment means defining a fulcrum about which a lever can pivot;
(2) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a female electrical connector coupled to said male electrical connector as said lever is pivoted from said up position to said down position.

16. An extension cord as in claim 15, wherein said upper portion of said lever comprises a finger pad.

17. An extension cord as in claim 16, wherein said finger pad is textured or contoured.

18. An extension cord as in claim 15, wherein said female connector is a female connector ejector comprising:
(a) a body; said body comprising a side surface and a mating surface, said mating surface having at least one conductive receiver adapted to receive a conductive projection, said body further comprising a channel extending from said side surface to said mating surface, said side surface having an attachment means defining a fulcrum about which a lever can pivot;
(b) a lever disposed in said channel of said body, said lever comprising an upper portion, an engagement means, and a lower portion, said lever pivotally attached to said body by securing said engagement means to said attachment means, said lever having an up position and a down position, said lever capable of disengaging a male electrical connector coupled to said male electrical connector as said lever is pivoted from said up position to said down position.

19. An extension cord as in claim 18, wherein said upper portion of said lever comprises a finger pad.

20. An extension cord as in claim 19, wherein said finger pad is textured or contoured.

21. A method for separating electrical connectors, which comprises:
(a) applying a force to at least one lever disposed in at least one of said electrical connectors, said force sufficient to separate said electrical connectors.

22. A method for separating electrical connectors, which comprises:
(a) displacing at least one lever disposed in at least one of said electrical connectors, said displacment causing said electrical connectors to separate.
